(19) United States
(12) Patent Application Publication
(10) Pub. No.: US 2014/0125707 A1
(43) Pub. Date: May 8, 2014

(54) COLOR PERFORMANCE AND IMAGE QUALITY USING FIELD SEQUENTIAL COLOR (FSC) TOGETHER WITH SINGLE-MIRROR IMODS

(71) Applicant: QUALCOMM MEMS TECHNOLOGIES, INC., San Diego, CA (US)

(72) Inventors: Alok Govil, Santa Clara, CA (US); Muhammed Ibrahim Sezan, Los Gatos, CA (US); Tallis Young Chang, San Diego, CA (US); Jian J. Ma, Carlsbad, CA (US); John Hyunchul Hong, San Clemente, CA (US)

(73) Assignee: QUALCOMM MEMS TECHNOLOGIES, INC., San Diego, CA (US)

(21) Appl. No.: 13/669,671

(22) Filed: Nov. 6, 2012

(51) Int. Cl. G02B 26/00; G09G 5/10

(52) U.S. Cl. 345/690; 359/290

(57) ABSTRACT

This disclosure provides systems, methods and apparatus, including computer programs encoded on computer storage media, for applying field-sequential color (FSC) methods to displays that include single-mirror interferometric modulators (IMODs), which may be multi-state IMODs or analog IMODs. In one aspect, grayscale levels may be provided by varying a mirror/absorber gap height between black and white states. In other implementations, grayscale levels may be obtained by varying the gap height between the black state and second-order color peaks.

### TECHNICAL FIELD

This disclosure relates to electromechanical systems and devices, and more particularly to electromechanical systems for implementing reflective display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Some IMODs are bi-stable IMODs, meaning that they can be configured in only two positions, open or closed. A single image pixel will typically include three or more bi-stable IMODs, each of which corresponds to a subpixel. In a display device that includes multi-state interferometric modulators (MS-IMODs) or analog IMODs (A-IMODs), a pixel's reflective color may be determined by the gap spacing or “height” between an absorber layer and a mirrored surface of a single IMOD. Some A-IMODs may be positioned in a substantially continuous manner between a large number of gap heights, whereas MS-IMODs generally may be positioned in a smaller number of gap heights. Because each mirror may correspond to a pixel in both types of devices, A-IMODs and MS-IMODs are treated herein as examples of the broader category of single-mirror IMODs (SM-IMODs). SM-IMODs can produce vivid, saturated colors under bright ambient light conditions. Although previous versions of SM-IMODs also can produce satisfactory results under low ambient light conditions, improved devices and methods would be desirable.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device that includes a front light including light sources for a plurality of colors. The display device may include an array of single-mirror interferometric modulators (SM-IMODs). The SM-IMODs may, for example, be multi-state IMODs or analog IMODs. Each of the SM-IMODs may include an absorber layer and a mirrored surface that define a gap height in between.

The display device may include a logic system configured for controlling an SM-IMOD to have a first configuration corresponding to a first gap height between the absorber layer and the mirrored surface, for controlling the front light to flash a first light source corresponding to a first color when the SM-IMOD is in the first configuration, for controlling the SM-IMOD to have a second configuration corresponding to a second gap height between the absorber layer and the mirrored surface and for controlling the front light to flash a second light source corresponding to a second color when the SM-IMOD is in the second configuration. The logic system may be configured to produce grayscale states by controlling the gaps and the front light colors.

The logic system also may be configured for controlling the SM-IMOD to have a third configuration corresponding to a third gap height between the absorber layer and the mirrored surface and for controlling the front light to flash a third light source corresponding to a third color when the SM-IMOD is in the third configuration. In some implementations, at least one of the first, second or third gap heights may be smaller than a gap height corresponding to a black state of the SM-IMOD. However, in alternative implementations at least one of the first, second or third gap heights may be larger than a gap height corresponding to a black state of the SM-IMOD. An image data frame may correspond to a time during which the logic system controls the SM-IMOD to be in the first, second and third configurations and controls the front light to flash the first, second and third colors.

At least one of the first, second or third configurations may correspond to a black state of the SM-IMOD. Each gap height may correspond to a reflectivity of the SM-IMOD for a particular wavelength of incident light. The logic system may be further configured for controlling the SM-IMOD to have a fourth configuration corresponding to a fourth gap height between the absorber layer and the mirrored surface and for controlling the front light to flash a fourth light source corresponding to a fourth color when the SM-IMOD is in the fourth configuration.

The logic system may be configured to cause the display device to operate in at least one field-sequential color (FSC) mode by controlling the SM-IMOD gaps and flashing the front light colors. In some implementations, the logic system may be configured to control the display device to operate in a grayscale FSC mode. The logic system may be configured to transition smoothly between an FSC mode and a non-FSC mode.

The display device may include an ambient light sensor configured for providing ambient light data to the logic system. The logic system may be configured to determine an operational mode for the display device based, at least in part, on the ambient light data.

The display device may include a memory device that is configured to communicate with the logic system. The logic system may include a processor that is configured to communicate with the array of SM-IMODs. The processor may be configured to process image data. The logic system also may include a driver circuit configured to send at least one signal to the array of multi-state IMODs and a controller configured to send at least a portion of the image data to the driver circuit. The logic system also may include an image source module configured to send the image data to the processor. For example, the image source module may be a receiver, transceiver, and/or transmitter. The display device also may include an input device configured to receive input data and to communicate the input data to the processor.

Another innovative aspect of the subject matter described in this disclosure can be implemented in a method that involves controlling an SM-IMOD to have a first configuration corresponding to a first gap height between an absorber layer and a mirrored surface, controlling a front light having light sources for a plurality of colors to flash a first light source corresponding to a first color when the SM-IMOD is in the first configuration, controlling the SM-IMOD to have a second configuration corresponding to a second gap height between the absorber layer and the mirrored surface and controlling the front light to flash a second light source corresponding to a second color when the SM-IMOD is in the second configuration.

The method also may involve controlling the SM-IMOD to have a third configuration corresponding to a third gap height between the absorber layer and the mirrored surface and controlling the front light to flash a third light source corresponding to a third color when the SM-IMOD is in the third configuration.

The controlling processes may involve controlling the front light and the SM-IMOD to operate in an FSC mode. The FSC mode may, for example, be a grayscale FSC mode.

Another innovative aspect of the subject matter described in this disclosure can be implemented in a non-transitory medium having software stored thereon. The software may include instructions for controlling an SM-IMOD to have a first configuration corresponding to a first gap height between an absorber layer and a mirrored surface, controlling a front light having light sources for a plurality of colors to flash a first light source corresponding to a first color when the SM-IMOD is in the first configuration, controlling the SM-IMOD to have a second configuration corresponding to a second gap height between the absorber layer and the mirrored surface and controlling the front light to flash a second light source corresponding to a second color when the SM-IMOD is in the second configuration.

The software also may include instructions for controlling the SM-IMOD to have a third configuration corresponding to a third gap height between the absorber layer and the mirrored surface and controlling the front light to flash a third light source corresponding to a third color when the SM-IMOD is in the third configuration.

The controlling processes may involve controlling the front light and the SM-IMOD to operate in an FSC mode. The FSC mode may be a grayscale FSC mode.

Another innovative aspect of the subject matter described in this disclosure can be implemented in a device that includes apparatus for controlling an SM-IMOD to have a first configuration corresponding to a first gap height between an absorber layer and a mirrored surface, apparatus for controlling a front light having light sources for a plurality of colors to flash a first light source corresponding to a first color when the SM-IMOD is in the first configuration, apparatus for controlling the SM-IMOD to have a second configuration corresponding to a second gap height between the absorber layer and the mirrored surface and apparatus for controlling the front light to flash a second light source corresponding to a second color when the SM-IMOD is in the second configuration.

The SM-IMOD may be a multi-state IMOD or an analog IMOD. The device also may include apparatus for controlling the SM-IMOD to have a third configuration corresponding to a third gap height between the absorber layer and the mirrored surface and apparatus for controlling the front light to flash a third light source corresponding to a third color when the SM-IMOD is in the third configuration.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (“LCDs”), transflective LCD displays, electrofluidic displays, electrophoretic displays, displays based on electro-wetting technology, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIGS. 5A and 5B are schematic exploded partial perspective views of a portion of an electromechanical systems (EMS) package including an array of EMS elements and a backplate.

FIGS. 6A-6E show examples of how a single-mirror IMOD (SM-IMOD) may be configured to produce different colors.

FIG. 7 is a system block diagram illustrating a display device including an IMOD array, a front light and a logic system.

FIG. 8 is a flow diagram illustrating a process for operating an IMOD display element and a front light.

FIG. 9A shows an example of a spectral response of an SM-IMOD with mirror/absorber gaps in the range of zero to about 150 nm.

FIG. 9B shows examples of SM-IMOD gaps for producing substantially the same shade of yellow as described above with reference to FIG. 9A, but with reduced brightness.

FIG. 9C shows examples of SM-IMOD gaps for producing substantially the same shade of yellow as described with reference to FIG. 9A, but a yellow that is about ⅓ as bright.

FIG. 10 shows an example of a spectral response of an SM-IMOD with mirror/absorber gaps in the range of zero to about 700 nm.

FIGS. 11A and 11B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations described herein can provide a high color gamut under low and mid ambient light conditions by operating a display device that includes a front light and SM-IMODs in one or more field-sequential color (“FSC”) modes. The SM-IMODs may include an absorber layer and a mirrored surface that define a gap.

The display device may be configured for controlling a SM-IMOD to have a first configuration corresponding to a first gap height between the absorber stack and the mirrored surface, for controlling the front light to flash a first light source corresponding to a first color when the SM-IMOD is in the first configuration, for controlling the SM-IMOD to have a second configuration corresponding to a second gap height between the absorber layer and the mirrored surface and for controlling the front light to flash a second light source corresponding to a second color when the SM-IMOD is in the second configuration. The display device may be configured for controlling the SM-IMOD to have a third configuration corresponding to a third gap height between the absorber layer and the mirrored surface and for controlling the front light to flash a third light source corresponding to a third color when the SM-IMOD is in the third configuration. A time during which the display device controls the SM-IMOD to be in the first, second and third configurations and controls the front light to flash the first, second and third colors may correspond to an image data frame.

The display device may be configured for controlling the SM-IMOD to have a fourth configuration corresponding to a fourth gap height between the absorber layer and the mirrored surface and for controlling the front light to flash a fourth light source corresponding to a fourth color when the SM-IMOD is in the fourth configuration. A time during which the display device controls the SM-IMOD to be in the first, second, third and fourth configurations and controls the front light to flash the first, second, third and fourth colors may correspond to an image data frame. In alternative implementations, the display device may be configured for controlling the SM-IMOD to have 5^{th} through N^{th} configurations corresponding to a 5^{th} through N^{th} gap heights between the absorber layer and the mirrored surface and for controlling the front light to flash 5^{th} through N^{th} light sources corresponding to 5^{th} through N^{th} colors when the SM-IMOD is in the 5^{th} through N^{th} configurations.

Some implementations provide a display device that may be configured for operation in FSC modes and non-FSC modes. The display device may be configured to transition smoothly between operation in an FSC mode and operation in a non-FSC mode.

Some of the FSC modes may be FSC grayscale modes. Some implementations may be configured for operation in FSC mode by varying a mirror/absorber gap height of an SM-IMOD between a black and a white state. Alternatively, or additionally, some implementations may be configured for operation in FSC mode by varying a mirror/absorber gap height of an SM-IMOD between a black state and a first-order color peak, a second-order color peak, or an N^{th} order color peak.

The front light may include light sources for a plurality of colors. In some implementations, the front light may include light sources for blue, green and red colors. The front light also may include light sources for other colors, such as yellow, yellow-orange, yellow-green, violet, cyan and/or magenta. In some implementations, the colors may differ in hue and/or saturation. Alternatively, or additionally, the colors may differ in intensity.

Particular implementations of the subject matter described in this disclosure can be implemented to realize one or more of the following potential advantages. Various implementations described herein can provide a high color gamut under relatively low and mid ambient light conditions. For example, a “relatively low” ambient light condition may correspond to an ambient light intensity of less than approximately 1000 lux. Moreover, various implementations described herein can provide a plurality of native grayscale states when operating an SM-IMOD in an FSC mode without necessarily requiring, for example, temporal modulation to generate gray levels. FSC operational modes may also reduce or eliminate color changes that may otherwise be caused by varying a viewing angle when the display is used under bright ambient light. Some FSC operational modes also may produce a white state that is less greenish than that of other SM-IMODs.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

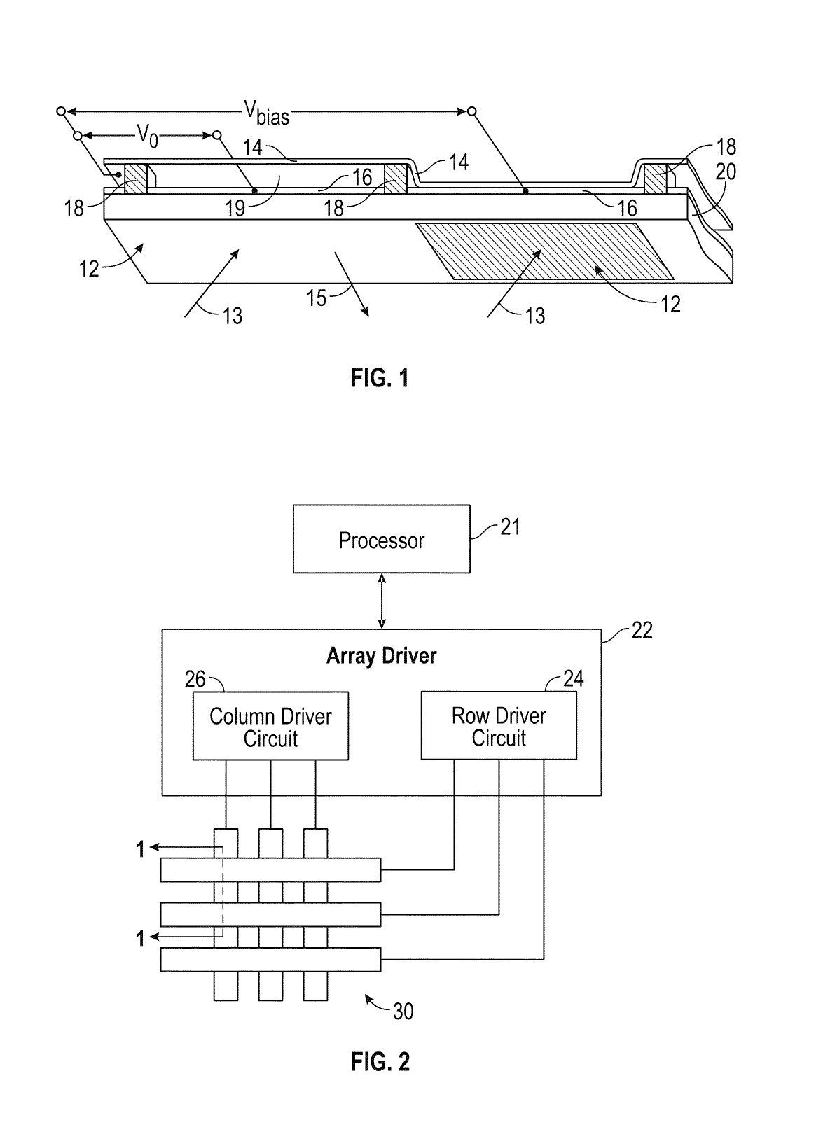

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

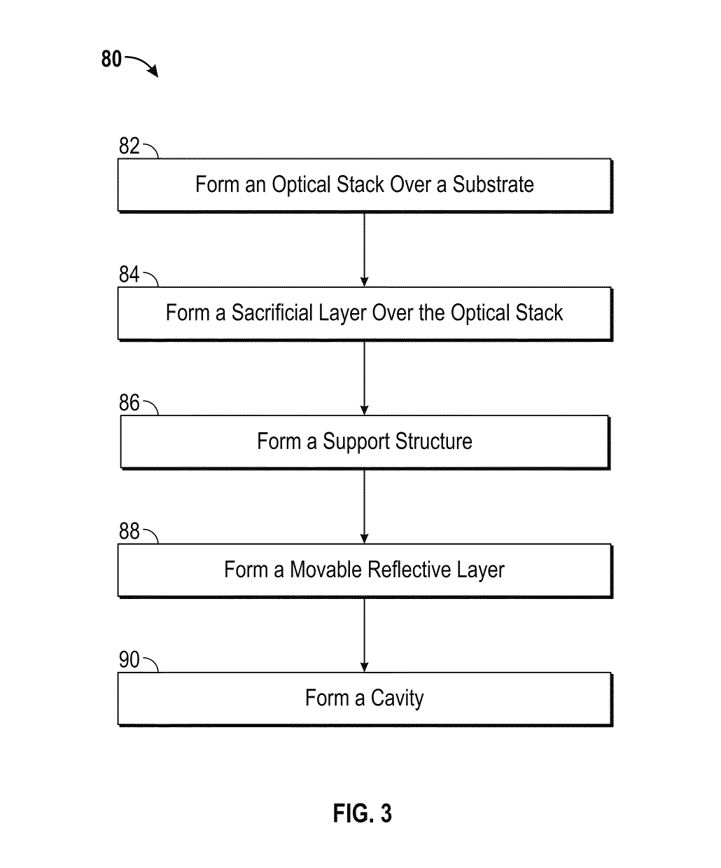

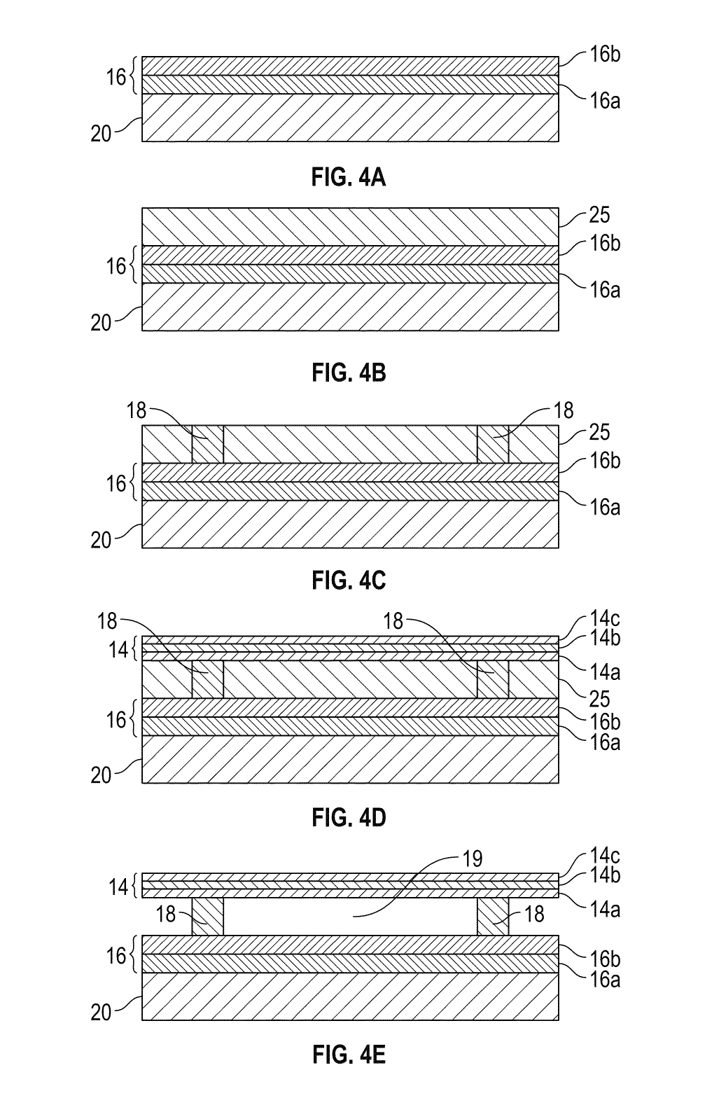

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 44. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

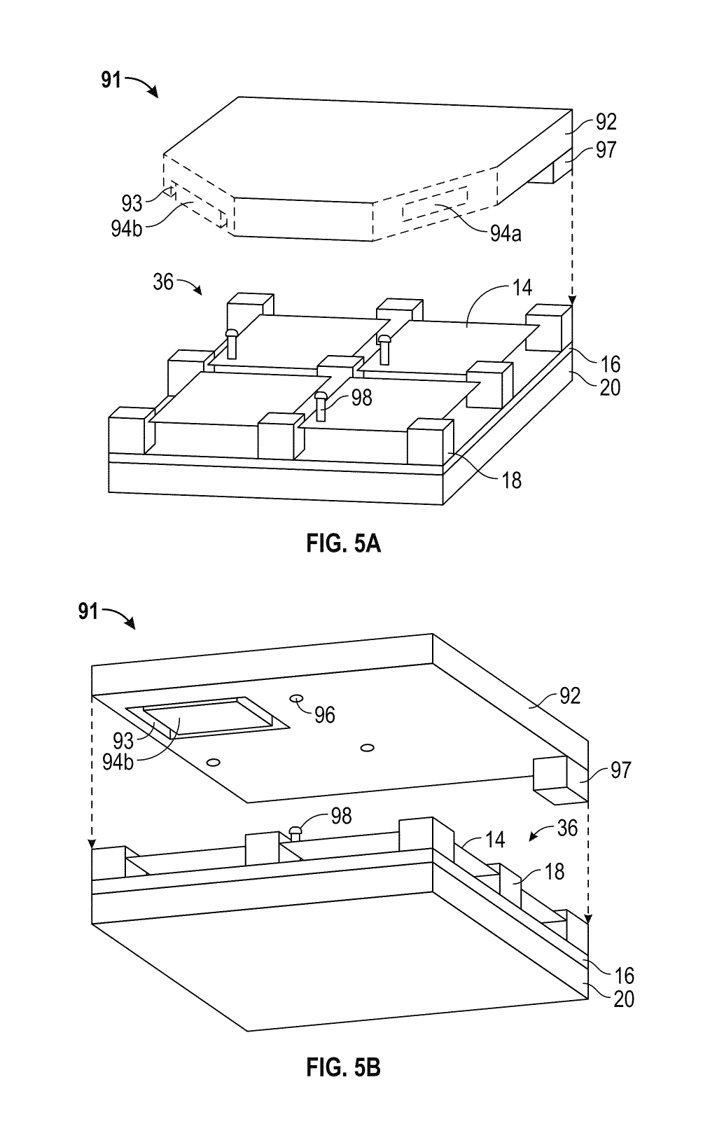

FIGS. 5A and 5B are schematic exploded partial perspective views of a portion of an EMS package 91 including an array 36 of EMS elements and a backplate 92. FIG. 5A is shown with two corners of the backplate 92 cut away to better illustrate certain portions of the backplate 92, while FIG. 5B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 5A and 5B, the backplate 92 can include one or more backplate components 94a and 94b, which can be partially or wholly embedded in the backplate 92. As can be seen in FIG. 5A, backplate component 94a is embedded in the backplate 92. As can be seen in FIGS. 5A and 5B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 5B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 5A and 5B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 5A and 5B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

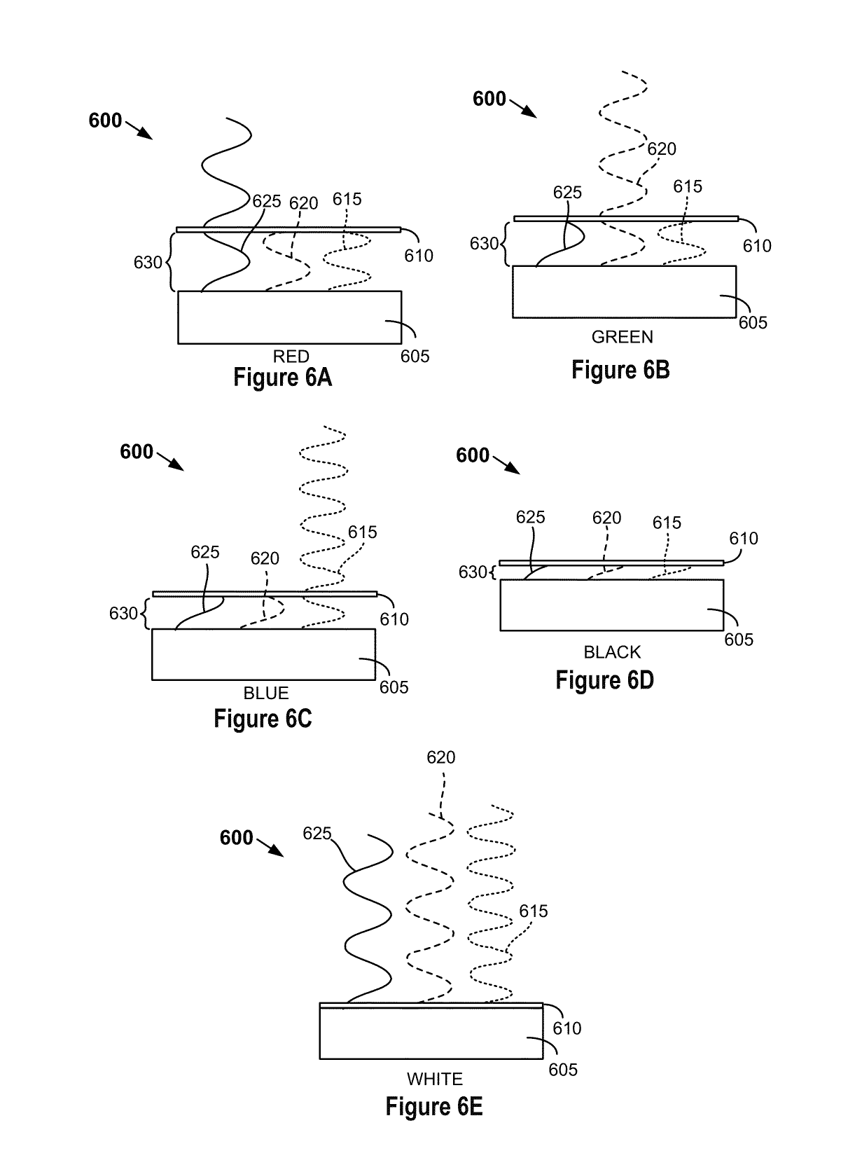

FIGS. 6A-6E show examples of how a single-mirror IMOD (SM-IMOD) may be configured to produce different colors. As noted above, multistate IMODs (MS-IMODs) and analog IMODs (A-IMODs) are both considered to be examples of the broader class of SM-IMODs.

In an SM-IMOD, a pixel's reflective color may be varied by changing the gap height between an absorber stack and a mirror stack. In FIGS. 6A-6E, the SM-IMOD 600 includes the mirror stack 605 and the absorber stack 610. In this implementation, the absorber stack 610 is partially reflective and partially absorptive. Here, the mirror stack 605 includes at least one metallic reflective layer, which also may be referred to herein as a mirrored surface.

In some implementations, the absorber layer may be formed of a partially absorptive and partially reflective layer. The absorber layer may be part of an absorber stack that includes other layers, such as one or more dielectric layers, an electrode layer, etc. According to some such implementations, the absorber stack may include a dielectric layer, a metal layer and a passivation layer. In some implementations, the dielectric layer may be formed of SiO₂, SiON, MgF₂, Al₂O₃ and/or other dielectric materials. In some implementations, the metal layer may be formed of Cr, W, Ni, V, Ti, Rh, Pt, Ge, Co and/or MoCr. In some implementations, the passivation layer may include Al₂O₃ or another dielectric material.

The mirrored surface may, for example, be formed of a reflective metal such as Al, silver, etc. The mirrored surface may be part of a mirror stack that includes other layers, such as one or more dielectric layers. Such dielectric layers may be formed of TiO₂, Si₃N₄, ZrO₂, Ta₂O₅, Sb₂O₃, HfO₂, Sc₂O₃, In₂O₃, Sn:In₂O₃, SiO₂, SiON, MgF₂, Al₂O₃, HfF₄, YbF₃, Na₃AlF₆ and/or other dielectric materials.

In FIGS. 6A-6E, the mirror stack 605 is shown at five positions relative to the absorber stack 610. However, an SM-IMOD 600 may be movable between substantially more than 5 positions relative to the mirror stack 605. For example, in some A-IMOD implementations, the gap height 630 between the mirror stack 605 and the absorber stack 610 may be varied in a substantially continuous manner. In some such SM-IMODs 600, the gap height 630 may be controlled with a high level of precision, e.g., with an error of 10 nm or less. Although the absorber stack 610 includes a single absorber layer in this example, alternative implementations of the absorber stack 610 may include multiple absorber layers. Moreover, in alternative implementations, the absorber stack 610 may not be partially reflective.

An incident wave having a wavelength λ will interfere with its own reflection from the mirror stack 605 to create a standing wave with local peaks and nulls. The first null is λ/2 from the mirror and subsequent nulls are located at λ/2 intervals. For that wavelength, a thin absorber layer placed at one of the null positions will absorb very little energy.

Referring first to FIG. 6A, when the gap height 630 is substantially equal to the half wavelength of a red color 625, the absorber stack 610 is positioned at the null of the red standing wave interference pattern. The absorption to the red wavelength is near zero because there is almost no red light at the absorber. At this configuration, constructive interference appears between red light reflected from the absorber stack 610 and red light reflected from the mirror stack 605. Therefore, light having a wavelength substantially corresponding to the red color 625 is reflected efficiently. Light of other colors, including the blue color 615 and the green color 620, has a high intensity field at the absorber and is not reinforced by constructive interference. Instead, such light is substantially absorbed by the absorber stack 610.

FIG. 6B depicts the SM-IMOD 600 in a configuration wherein the mirror stack 605 is moved closer to the absorber stack 610 (or vice versa). In this example, the gap height 630 is substantially equal to the half wavelength of the green color 620. The absorber stack 610 is positioned at the null of the green standing wave interference pattern. The absorption to the green wavelength is near zero because there is almost no green light at the absorber. At this configuration, constructive interference appears between green light reflected from the absorber stack 610 and green light reflected from the mirror stack 605. Light having a wavelength substantially corresponding to the green color 620 is reflected efficiently. Light of other colors, including the red color 625 and the blue color 615, is substantially absorbed by the absorber stack 610.

In FIG. 6C, the mirror stack 605 is moved closer to the absorber stack 610 (or vice versa), so that the gap height 630 is substantially equal to the half wavelength of the blue color 615. Light having a wavelength substantially corresponding to the blue color 615 is reflected efficiently. Light of other colors, including the red color 625 and the green color 620, is substantially absorbed by the absorber stack 610.

In FIG. 6D, however, the SM-IMOD 600 is in a configuration wherein the gap height 630 is substantially equal to ¼ of the wavelength of the average color in the visible range. In such arrangement, the absorber is located near the intensity peak of the interference standing wave; the strong absorption due to high field intensity together with destructive interference between the absorber stack 610 and the mirror stack 605 causes relatively little visible light to be reflected from the SM-IMOD 600. This configuration may be referred to herein as a “black state.” In some such implementations, the gap height 630 may be made larger or smaller than shown in FIG. 6D, in order to reinforce other wavelengths that are outside the visible range. Accordingly, the configuration of the SM-IMOD 600 shown in FIG. 6D provides merely one example of a black state configuration of the SM-IMOD 600.

FIG. 6E depicts the SM-IMOD 600 in a configuration wherein the absorber stack 610 is substantially adjacent to the mirror stack 605. In this example, the gap height 630 is negligible. Light having a broad range of wavelengths is reflected efficiently from the mirror stack 605 without being absorbed to a significant degree by the absorber stack 610. This configuration may be referred to herein as a “white state.” However, the absorber stack 610 and the mirror stack 605 should be separated to reduce stiction caused by charging via the strong electric field that may be produced when the two layers are brought close to one another. In some implementations, one or more dielectric layers with a total thickness of about λ/2 may be disposed on the surface of the absorber stack 610 and/or the mirror stack 605. As such, the white state is when the absorber is placed at the first null of the standing wave away from a reflective metal layer in the mirror stack 605.

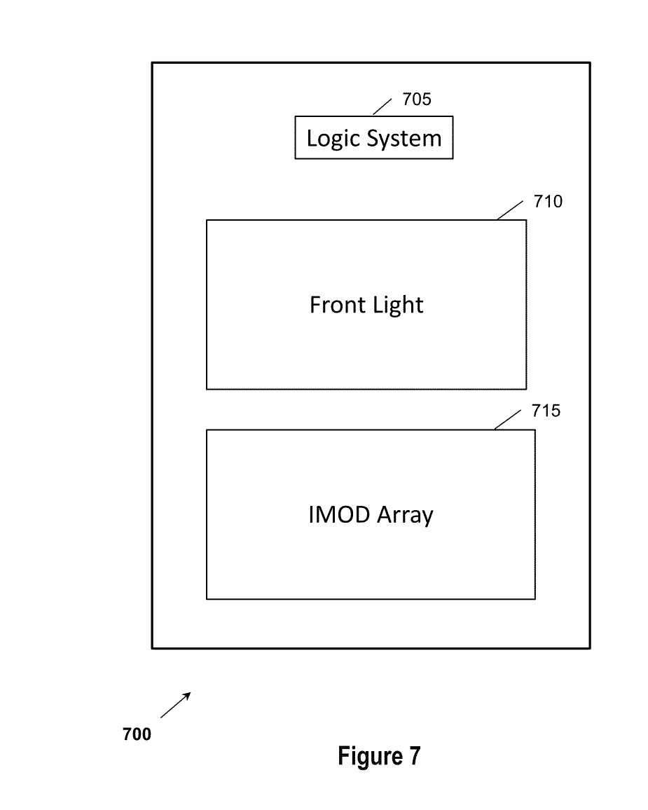

Some examples of applying FSC techniques to SM-IMODs will now be described with reference to FIGS. 7-10. FIG. 7 is a system block diagram illustrating a display device including an IMOD array, a front light and a logic system. In this example, the display device 700 includes a logic system 705, a front light 710 and an IMOD array 715.

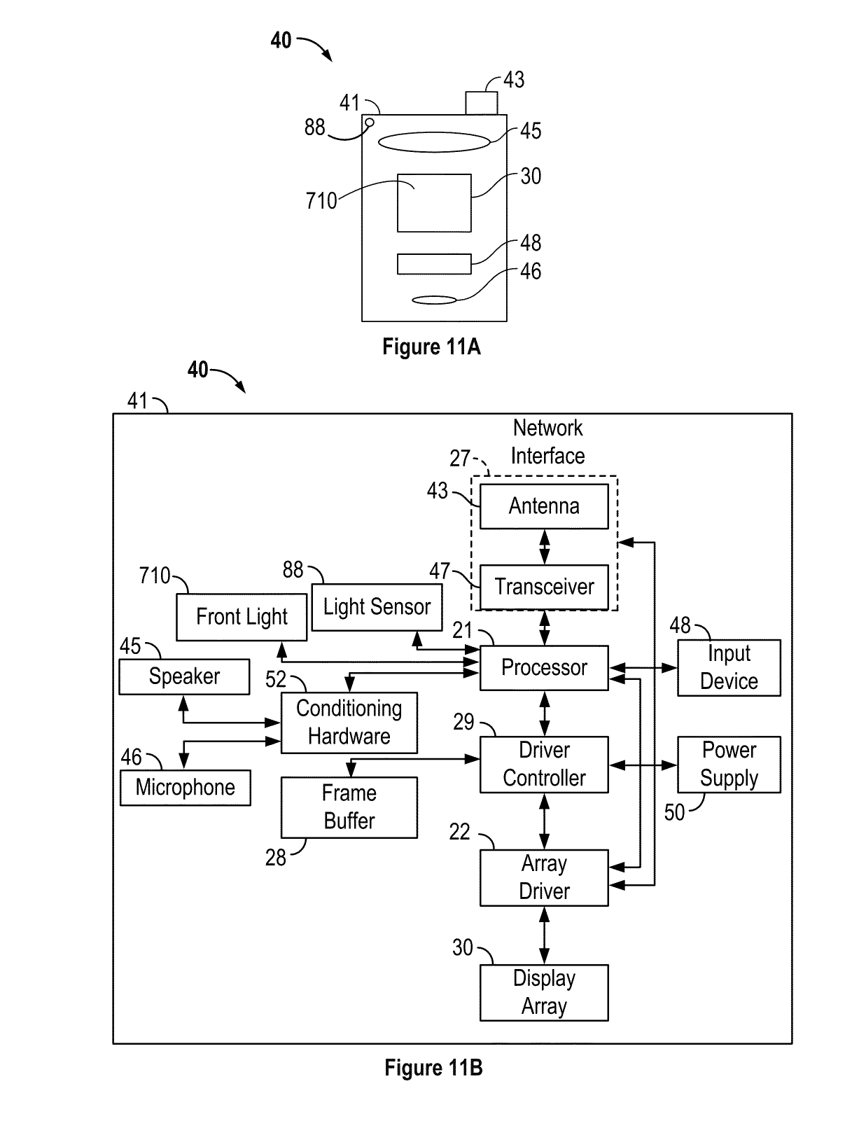

The logic system 705 may, for example, include at least one of a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof. According to some implementations, the logic system 705 may include the processor 21, the driver controller 29, the array driver and/or other elements that are shown in FIG. 11B and are described below. The logic system 705 may be configured to control the front light 710 and the IMOD array 715 to operate in at least one FSC mode. The logic system 705 may be configured to control the front light 710 and the IMOD array 715 to transition between operation in an FSC mode and operation in a non-FSC mode.

For example, in some implementations the logic system 705 may be configured to control the front light 710 and the IMOD array 715 to make such transitions according to input from an ambient light sensor, a user input system, etc., such as shown in FIG. 11B and described below. According to some such implementations, the logic system 705 may be configured to determine an operational mode for the display device 700 based, at least in part, on ambient light data from the ambient light sensor. The logic system 705 may be configured to control the front light 710 and the IMOD array 715 to transition smoothly from operation in an FSC mode to operation in a non-FSC mode when the ambient light sensor indicates that the ambient light intensity level has increased beyond a predetermined threshold. As compared to some previously developed FSC implementations for bi-stable IMODs, the transition from an FSC mode to operation in a non-FSC mode (or vice versa) may be performed relatively more smoothly. In a bi-stable IMOD display, red, green and blue stripes may be configured to run parallel to scan lines of the display. One issue that may prevent a smooth transition is that in some FSC modes for bi-stable IMOD implementations, when red data are written to the display, green and blue are driven dark. Accordingly, green and blue channels are not written with any content data in such implementations, but such content data would be written when the bi-stable IMOD display is used under bright ambient light. At least one non-FSC mode may, for example, involve leaving one or more light sources of the front light 710 continuously on. Another non-FSC mode may involve switching off the front light 710.

In some implementations, the front light 710 may at least partially overlie the IMOD array 715. The front light 710 may include a substantially transparent wave guide and light-extracting elements such as prisms, dots, etc., that are configured to illuminate the IMOD array 715 with light sources of various colors. For example, the front light 710 may include light sources corresponding to at least a first color and a second color. The front light 710 also may include light sources corresponding to a third color, a fourth color and/or other colors. In some implementations, the front light 710 may include light sources for blue, green and red colors. Alternatively, or additionally, the front light 710 may include light sources for other colors, such as yellow, yellow-orange, yellow-green, violet, cyan, white and/or magenta.

The IMOD array 715 may include a plurality of SM-IMODs. As used herein, analog IMODs are considered to be one type of SM-IMODs. Accordingly, the IMOD array 715 may include a plurality of analog IMODs. Each of the IMODs may have an absorber layer and a mirrored surface. The IMODs may be configured to define a gap height in between the absorber layer and a mirrored surface. As described above with reference to FIGS. 6A-6E, a gap height may correspond to a wavelength range of light that emerges from the IMOD after being reflected by the mirrored surface and partially absorbed by the absorber layer.

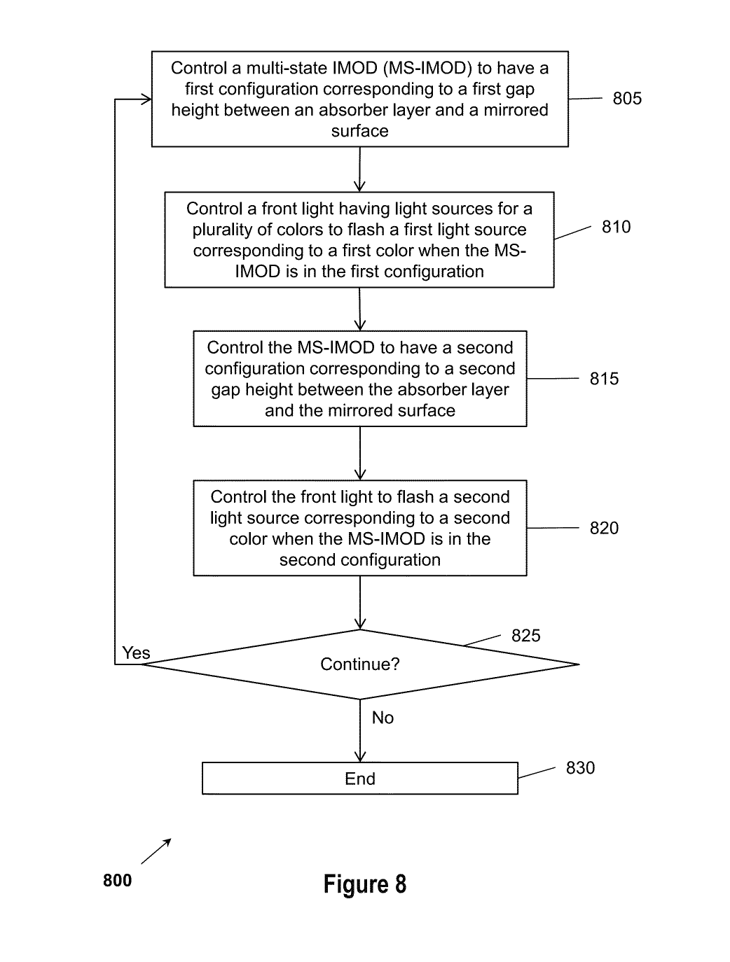

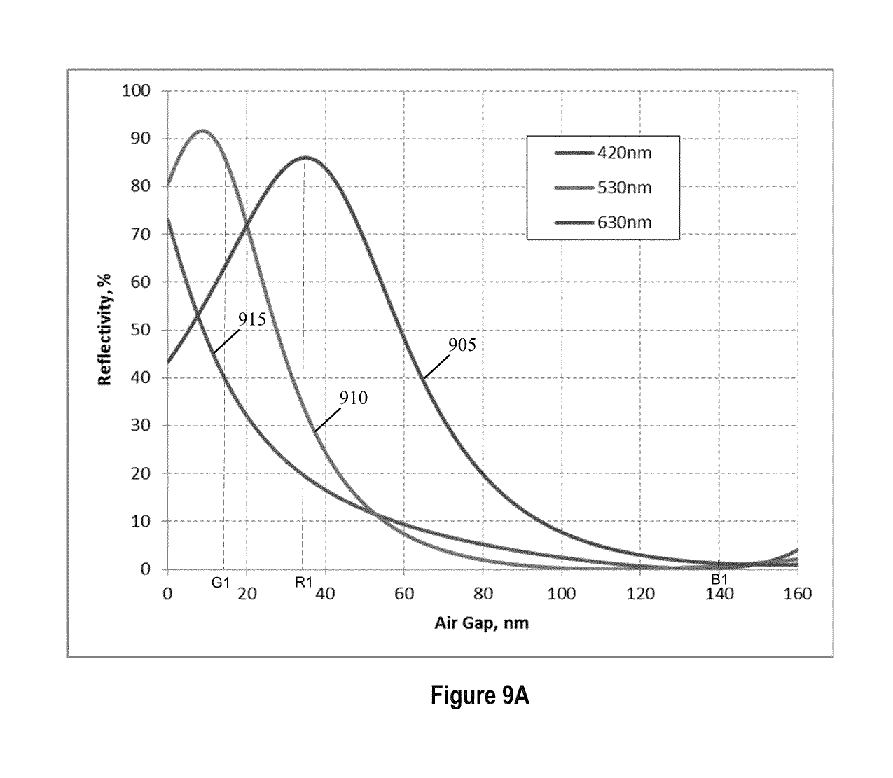

FIG. 8 is a flow diagram illustrating a process for operating an IMOD display element and a front light. For example, the method 800 may be performed by the logic system 705 of FIG. 7, for controlling the front light 710 and an IMOD element of the IMOD array 715. In some implementations, the method 800 may involve controlling the front light and the SM-IMOD to operate in an FSC mode. The FSC mode may, in some implementations, be a grayscale FSC mode.

In this example, the method 800 begins by controlling an SM-IMOD to have a first configuration corresponding to a first gap height between an absorber layer and a mirrored surface (block 805). As noted elsewhere herein, in some implementations the SM-IMOD may be an analog IMOD. The gap height may correspond to a reflectivity of the IMOD for a particular wavelength of incident light.

In this implementation, block 810 involves controlling a front light to flash a first light source corresponding to a first color when the SM-IMOD is in the first configuration. In this example, the front light has light sources for a plurality of colors, like the front light 710.

In this example, block 815 involves controlling the SM-IMOD to have a second configuration corresponding to a second gap height between the absorber layer and the mirrored surface. While the SM-IMOD is in the second configuration, the front light may be controlled to flash a second light source corresponding to a second color (block 820).

In the example shown in FIG. 8, it is determined in block 825 whether the method 800 will continue. If so, the method 800 may revert to block 805. If the method 800 will not continue, the process may end (block 830).

In some implementations, the block 825 may involve determining whether to continue operating the display device, e.g., according to input from a user. Alternatively, or additionally, the block 825 may involve determining whether to change the operational mode of the display device, e.g., according to input from an ambient light sensor as describe above.

Alternatively, or additionally, the block 825 may involve determining whether an image data frame is complete. In this example, the image data frame is complete after two light source colors have been flashed during times when the SM-IMOD was in two configurations.

However, in alternative implementations, a data frame will not be complete until three or more light source colors have been flashed during times when the SM-IMOD was in three or more configurations. For example, alternative methods may involve controlling the SM-IMOD to have a third configuration corresponding to a third gap height between the absorber layer and the mirrored surface and controlling the front light to flash a third light source corresponding to a third color when the SM-IMOD is in the third configuration. The block 825 may involve determining whether an image data frame is complete. For example, the image data frame may be complete after three light source colors have been flashed during times when the SM-IMOD was in three configurations.

However, alternative implementations may involve controlling the SM-IMOD to have a fourth configuration corresponding to a fourth gap height between the absorber layer and the mirrored surface and controlling the front light to flash a fourth light source corresponding to a fourth color when the SM-IMOD is in the fourth configuration. It may be determined in block 825 that the image data frame may be complete after four light source colors have been flashed during times when the SM-IMOD was in four configurations.

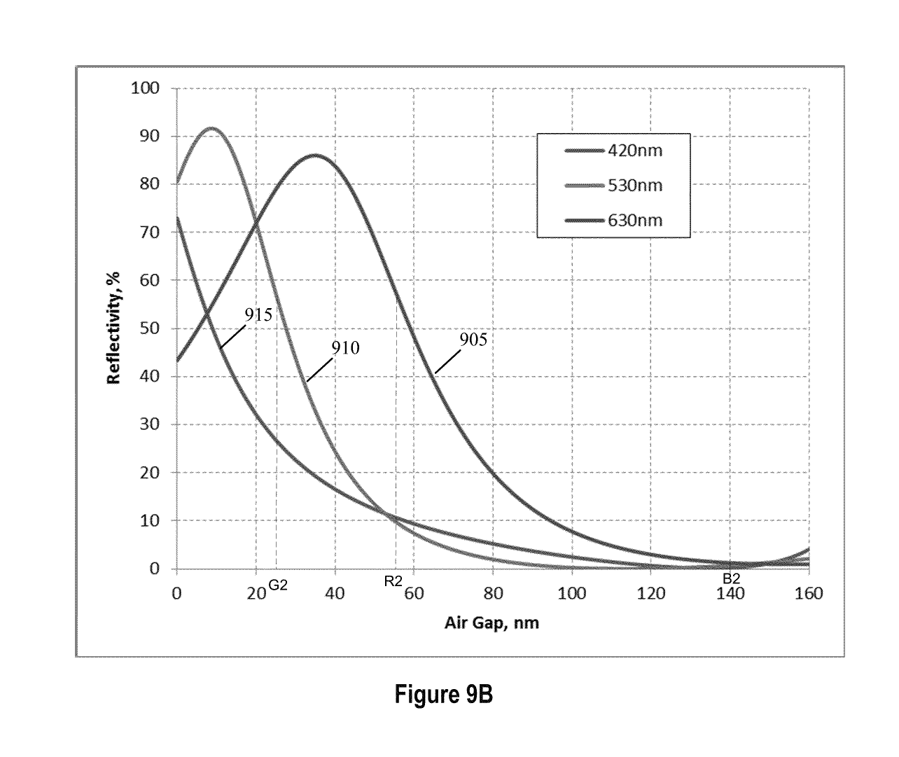

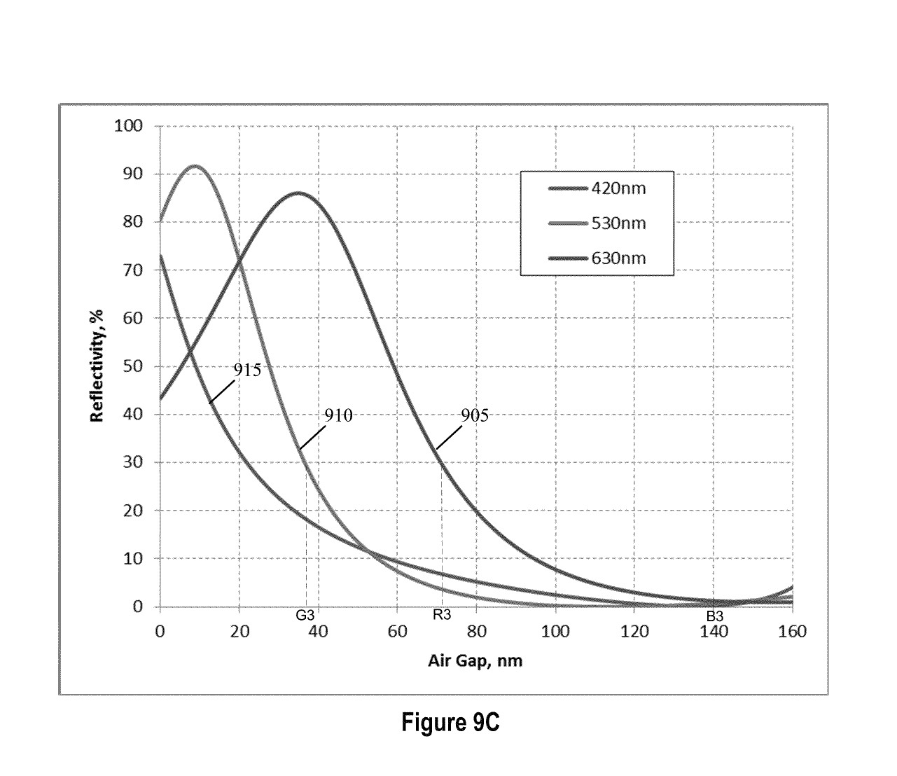

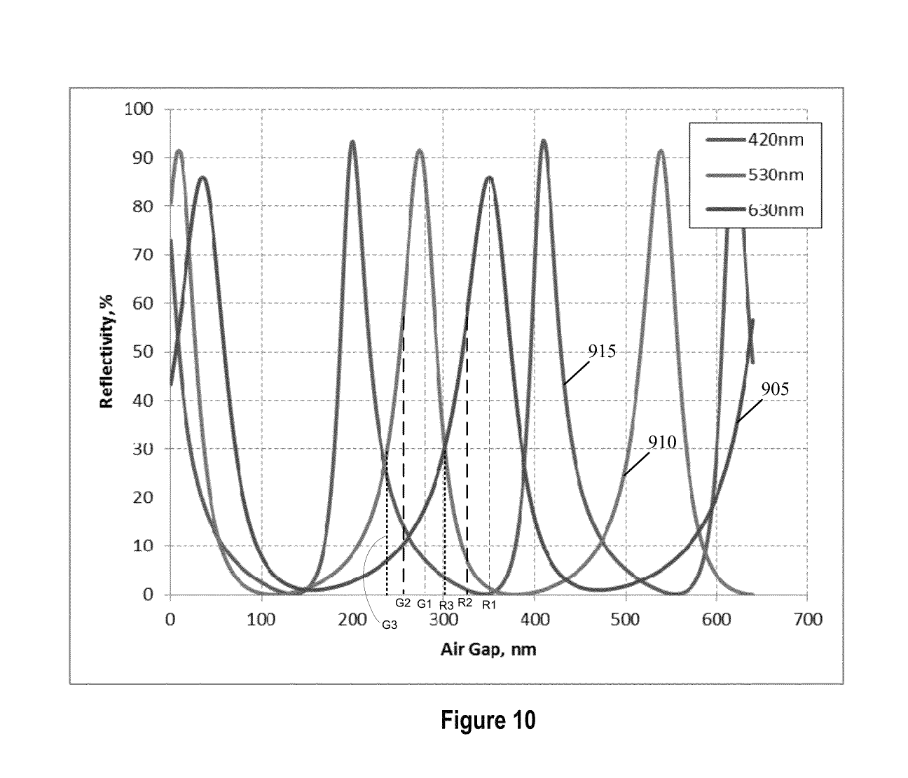

The gap heights may also vary according to the implementation. For example, in some implementations, the gap heights may be less than or equal to a gap height that corresponds with a black state of the SM-IMOD. Some such implementations, including some grayscale FSC implementations, are described below with reference to FIG. 9A-9C. Alternatively, or additionally, in some implementations the gap heights may be greater than or equal to a gap height that corresponds with the black state of the SM-IMOD. Some such implementations are described below with reference to FIG. 10.

Some implementations for controlling SM-IMODs according to FSC techniques will now be described with reference to FIGS. 9A-9C. In FIGS. 9A-10, the standing wave interference pattern for 630 nm (red) is represented by the curve 905, the standing wave interference pattern for 530 nm (green) is represented by the curve 910 and the standing wave interference pattern for 420 nm (blue) is represented by the curve 915.

FIGS. 9A-9C show an example of a spectral response of an SM-IMOD with mirror/absorber gaps in the range of zero to about 160 nm. For example, FIG. 9A shows a range of gaps that include a white state (corresponding to a gap height of approximately 8-10 nm) similar to that shown in FIG. 6E and a black state (corresponding to a gap height of approximately 140 nm) similar to that shown in FIG. 6D. In this example, the white state is not a pure white. The whitest state is produced near the green peak, at gaps near 10 nm, so the white state will have a greenish hue. The first-order red peak shown at approximately 34 nm in FIG. 9A corresponds with the red state shown in FIG. 6A, whereas the first-order green peak shown at approximately 9 nm in FIG. 9A corresponds with the green state shown in FIG. 6B.

FIG. 9A shows an example of how an SM-IMOD could be controlled to produce a particular shade of yellow when operated in an FSC mode. A wide range of colors may be produced in a similar manner.

Here, the yellow color has substantially equal amounts of red and green. The brightest yellow will be produced by configuring the SM-IMOD with a gap height G1 when the SM-IMOD is being illuminated with a green light and by configuring the SM-IMOD with a gap height R1 when the SM-IMOD is being illuminated with a red light. In this example, no blue component is desired, so the SM-IMOD is configured with a gap height B1 when the SM-IMOD is being illuminated with a blue light. B1 corresponds to a gap height at which the SM-IMOD will reflect little or no blue light.

In some implementations, a color may not be flashed if that color will not contribute significantly to the combined color. For example, in the situation depicted in FIG. 9A, the blue light may not be flashed. Instead, the SM-IMOD may be configured with the gap height G1 for half a data frame, during which time the green light may be illuminated. The SM-IMOD may be configured with the gap height R1 for the other half of the data frame, during which time the red light may be illuminated.

Using similar principles, some FSC operational modes also may produce a more pure (less green) white state. According to some such implementations, the SM-IMOD may be configured with a gap height of less than 5 nm (e.g., 2 or 3 nm) when the blue light is flashed, yielding a blue reflectivity of approximately 70%. In order to substantially match this reflectivity, the gap height may be slightly less than 20 nm when the red light is flashed and slightly greater than 20 nm when the green light is flashed.

Some grayscale FSC examples will now be discussed with reference to FIGS. 9B and 9C. FIG. 9B shows examples of SM-IMOD gaps for producing substantially the same shade of yellow as described above with reference to FIG. 9A, but with reduced brightness. A yellow that is approximately ⅔ as bright can be produced by configuring the SM-IMOD with a gap height G2 when the SM-IMOD is being illuminated with a green light and by configuring the SM-IMOD with a gap height R2 when the SM-IMOD is being illuminated with a red light. In this example, the SM-IMOD is configured with a gap height B2 when the SM-IMOD is being illuminated with a blue light. B2 is substantially the same as B1.

FIG. 9C shows examples of SM-IMOD gaps for producing substantially the same shade of yellow as described with reference to FIG. 9A, but a yellow that is about ⅓ as bright. Here, the SM-IMOD is configured with a gap height G3 when the SM-IMOD is being illuminated with a green light and with a gap height R3 when the SM-IMOD is being illuminated with a red light. In this example, the SM-IMOD is configured with a gap height B3, which is substantially the same as B1, when the SM-IMOD is being illuminated with a blue light.

In some grayscale FSC implementations, grayscale levels may be obtained by varying the gap height between the black state and second-order color peaks. FIG. 10 shows an example of a spectral response of an SM-IMOD with mirror/absorber gaps in the range of zero to about 700 nm.

Here, as above, a yellow color that has substantially equal amounts of red and green is being produced by the SM-IMOD. The brightest yellow will be produced by configuring the SM-IMOD with a gap height G1 when the SM-IMOD is being illuminated with a green light, by configuring the SM-IMOD with a gap height R1 when the SM-IMOD is being illuminated with a red light and by configuring the SM-IMOD with a gap height B1 when the SM-IMOD is being illuminated with a blue light.

A yellow that is substantially the same shade but about ⅔ as bright can be produced by configuring the SM-IMOD with a gap height G2 when the SM-IMOD is being illuminated with a green light and with a gap height R2 when the SM-IMOD is being illuminated with a red light. In this example, the SM-IMOD is configured with a gap height B2 when the SM-IMOD is being illuminated with a blue light. B2 is substantially the same as B1.

In order to produce substantially the same shade of yellow, but about ⅓ as bright, the SM-IMOD may be configured with a gap height G3 when the SM-IMOD is being illuminated with a green light and with a gap height R3 when the SM-IMOD is being illuminated with a red light. In this example, the SM-IMOD is configured with a gap height B3, which is substantially the same as B1, when the SM-IMOD is being illuminated with a blue light.

In the foregoing examples, three different grayscale levels were produced. However, in alternative examples, more or fewer grayscale levels may be produced.

As noted above, in some alternative implementations a color may not be flashed if that color will not contribute significantly to the combined color. For example, in the situations depicted in FIGS. 9B, 9C and 10, the blue light may not be flashed. According to some such implementations, the SM-IMOD may be configured with the gap height G1, G2 or G3 for half a data frame, during which time the green light may be illuminated, and the SM-IMOD may be configured with the gap height R1, R2 or R3 for the other half of the data frame, during which time the red light may be illuminated.

FIGS. 11A and 11B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or SM-IMOD display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

In this example, the display device 40 includes a front light 710. The front light 710 may provide light to the display 30 when there is insufficient ambient light. The front light 710 may include one or more light sources and light-turning features configured to direct light from the light source(s) to an array of SM-IMODs. The front light 710 may also include a wave guide and/or reflective surfaces, e.g., to direct light from the light source(s) into the wave guide. In some implementations, the front light 710 may be configured to provide red, green, blue, yellow, yellow-green, yellow-orange, cyan, magenta and/or other colors of light, e.g., as described herein. However, in other implementations the front light 710 may be configured to provide substantially white light.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

In this example, the processor 21 is configured to control the front light 710. According to some implementations, the processor 21 is configured to control the front light 710 in accordance with one or more of the field-sequential color methods described herein. In some such implementations, the processor 21 is configured to control the front light 710 according to data from ambient light sensor 88. For example, the processor 21 may be configured to select one of the field-sequential color method described herein and to control the front light 710 based, at least in part, on the brightness of ambient light. Alternatively, or additionally, the processor 21 may be configured to select one of the field-sequential color methods described herein and/or to control the front light 710 based on user input. The processor 21, the driver controller 29 and/or other devices may control the interferometric modulator display in accordance with one or more of the field-sequential color methods and/or grayscale methods described herein.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device, comprising:
a front light including light sources for a plurality of colors;
an array of single-mirror interferometric modulators (SM-IMODs), each of the SM-IMODs including an absorber layer and a mirrored surface that define a gap height in between; and
a logic system configured for:
controlling an SM-IMOD to have a first configuration corresponding to a first gap height between the absorber layer and the mirrored surface;
controlling the front light to flash a first light source corresponding to a first color when the SM-IMOD is in the first configuration;
controlling the SM-IMOD to have a second configuration corresponding to a second gap height between the absorber layer and the mirrored surface; and
controlling the front light to flash a second light source corresponding to a second color when the SM-IMOD is in the second configuration.

2. The display device of claim 1, wherein the logic system is further configured for:
controlling the SM-IMOD to have a third configuration corresponding to a third gap height between the absorber layer and the mirrored surface; and
controlling the front light to flash a third light source corresponding to a third color when the SM-IMOD is in the third configuration.

3. The display device of claim 2, wherein an image data frame corresponds to a time during which the logic system controls the SM-IMOD to be in the first, second and third configurations and controls the front light to flash the first, second and third colors.

4. The display device of claim 2, wherein the logic system may be configured to cause the display device to operate in at least one field-sequential color (FSC) mode by controlling the SM-IMOD gaps and flashing the front light colors.

5. The display device of claim 4, wherein the logic system is configured to control the display device to operate in a grayscale FSC mode.

6. The display device of claim 4, wherein the logic system is configured to transition smoothly between an FSC mode and a non-FSC mode.

7. The display device of claim 2, at least one of the first, second or third gap heights is smaller than a gap height corresponding to a black state of the SM-IMOD.

8. The display device of claim 2, at least one of the first, second or third gap heights is larger than a gap height corresponding to a black state of the SM-IMOD.

9. The display device of claim 2, at least one of the first, second or third configurations corresponds to a black state of the SM-IMOD.

10. The display device of claim 2, wherein each gap height corresponds to a reflectivity of the SM-IMOD for a particular wavelength of incident light.

11. The display device of claim 2, wherein the logic system is further configured for:
controlling the SM-IMOD to have a fourth configuration corresponding to a fourth gap height between the absorber layer and the mirrored surface; and
controlling the front light to flash a fourth light source corresponding to a fourth color when the SM-IMOD is in the fourth configuration.

12. The display device of claim 1, wherein the logic system is configured to produce grayscale states by controlling the gaps and the front light colors.

13. The display device of claim 1, further including an ambient light sensor configured for providing ambient light data to the logic system, wherein the logic system is further configured to determine an operational mode for the display device based, at least in part, on the ambient light data.

14. The display device of claim 1, wherein the SM-IMODs are multi-state IMODs or analog IMODs.

15. The display device of claim 1, further comprising:
a memory device that is configured to communicate with the logic system, wherein the logic system includes a processor that is configured to communicate with the array of SM-IMODs, the processor being configured to process image data.

16. The display device of claim 15, wherein the logic system further comprises:
a driver circuit configured to send at least one signal to the array of multi-state IMODs; and
a controller configured to send at least a portion of the image data to the driver circuit.

17. The display device of claim 15, wherein the logic system further comprises:
an image source module configured to send the image data to the processor, wherein the image source module comprises at least one of a receiver, transceiver, and transmitter.

18. The display device of claim 15, further comprising:
an input device configured to receive input data and to communicate the input data to the processor.

19. A method, comprising:
controlling a single-mirror interferometric modulator (SM-IMOD) to have a first configuration corresponding to a first gap height between an absorber layer and a mirrored surface;
controlling a front light having light sources for a plurality of colors to flash a first light source corresponding to a first color when the SM-IMOD is in the first configuration;
controlling the SM-IMOD to have a second configuration corresponding to a second gap height between the absorber layer and the mirrored surface; and
controlling the front light to flash a second light source corresponding to a second color when the SM-IMOD is in the second configuration.

20. The method of claim 19, further comprising:
controlling the SM-IMOD to have a third configuration corresponding to a third gap height between the absorber layer and the mirrored surface; and
controlling the front light to flash a third light source corresponding to a third color when the SM-IMOD is in the third configuration.

21. The method of claim 19, wherein the controlling processes involve controlling the front light and the SM-IMOD to operate in a field-sequential color (FSC) mode.

22. The method of claim 21, wherein the FSC mode is a grayscale FSC mode.

23. A non-transitory medium having software stored thereon, the software including instructions for the following:
controlling a single-mirror interferometric modulator (SM-IMOD) to have a first configuration corresponding to a first gap height between an absorber layer and a mirrored surface;
controlling a front light having light sources for a plurality of colors to flash a first light source corresponding to a first color when the SM-IMOD is in the first configuration;
controlling the SM-IMOD to have a second configuration corresponding to a second gap height between the absorber layer and the mirrored surface; and
controlling the front light to flash a second light source corresponding to a second color when the SM-IMOD is in the second configuration.

24. The non-transitory medium of claim 23, wherein the software includes instructions for the following:
controlling the SM-IMOD to have a third configuration corresponding to a third gap height between the absorber layer and the mirrored surface; and
controlling the front light to flash a third light source corresponding to a third color when the SM-IMOD is in the third configuration.

25. The non-transitory medium of claim 23, wherein the controlling processes involve controlling the front light and the SM-IMOD to operate in a field-sequential color (FSC) mode.

26. The non-transitory medium of claim 23, wherein the FSC mode is a grayscale FSC mode.

27. An apparatus, comprising:
means for controlling a single-mirror interferometric modulator (SM-IMOD) to have a first configuration corresponding to a first gap height between an absorber layer and a mirrored surface;
means for controlling a front light having light sources for a plurality of colors to flash a first light source corresponding to a first color when the SM-IMOD is in the first configuration;
means for controlling the SM-IMOD to have a second configuration corresponding to a second gap height between the absorber layer and the mirrored surface; and
means for controlling the front light to flash a second light source corresponding to a second color when the SM-IMOD is in the second configuration.

28. The apparatus of claim 27, wherein the SM-IMOD is a multi-state IMOD or an analog IMOD.

29. The apparatus of claim 27, further comprising:
means for controlling the SM-IMOD to have a third configuration corresponding to a third gap height between the absorber layer and the mirrored surface; and
means for controlling the front light to flash a third light source corresponding to a third color when the SM-IMOD is in the third configuration.
